(19) United States
(12) Patent Application Publication
(10) Pub. No.: US 2003/0027699 A1
(43) Pub. Date: Feb. 6, 2003

(54) Punch holder for automatic tool changer

(76) Inventors: Ryan Brodie, Uniontown, OH (US); Jerry Spence, Ravenna, OH (US)

Correspondence Address: Ryan Brodie, P.O. Box 729, 666 Pratt Street, Ravenna, OH, 44266, US

(21) Appl. No.: 09/922,605

(22) Filed: Aug. 6, 2001

(51) Int. Cl. B23Q 3/155

(52) U.S. Cl. 483/28; 83/559

(57) ABSTRACT

A tool holder assembly to hold and orient punches in numerically controlled punch presses which utilize automatic tool changers. The holder positions and orients round and shaped standard insert punches to ensure proper alignment with mating dies during operation. The tool holder comprising a body and a base with indexing pins which provide secure and unique positioning of the insert punch. Application of this invention allows maximum tool life by ensuring proper tool orientation and reduces operation costs by allowing use of standard, low cost, insert punches.

### BACKGROUND

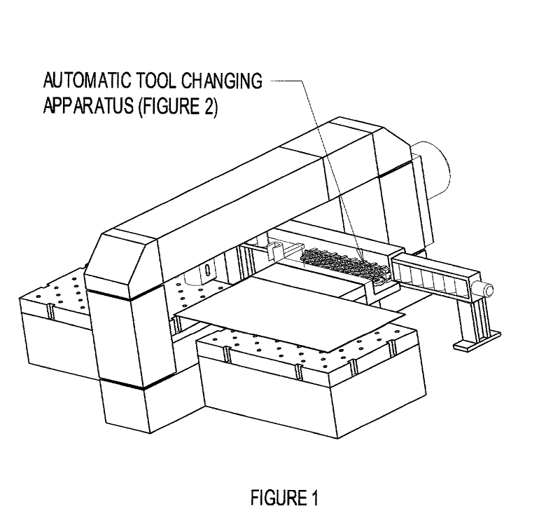

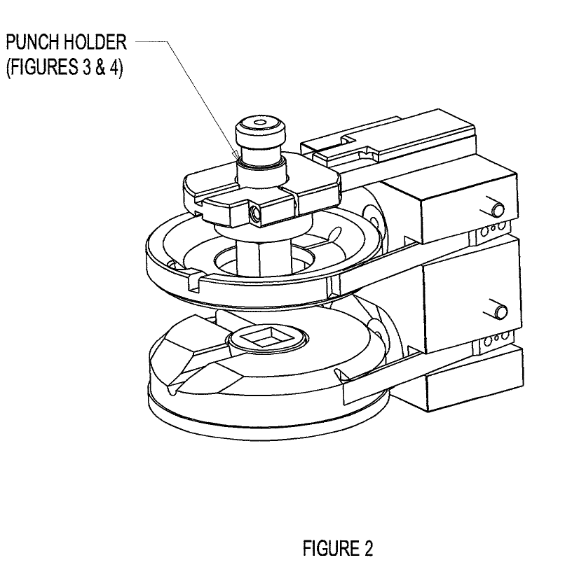

Numerically controlled punch presses (FIG. 1) with automatic tool changers provide an efficient and cost effective means for many sheet metal manufacturing processes. Automatic tool changers (FIG. 2), although very effective, impose special problems for tooling manufacturers. Because of the need for extreme rigidity and consistency in dimension tooling must be closely machined to a specified geometry to be compatible with the tool changing mechanism. Consequently, the head and shank of tools regardless of size must be of consistent dimension and geometry to fit the tool changer. When producing small size holes requiring smaller tooling the requirement for the relatively massive head and shank to fit the changer mechanism results in expensive punches compared to the standard size tooling to produce the same size holes.

It is the intent of this invention to reduce the tooling costs to produce small size holes with automated machines using automatic tool changers by providing a tool holder which accepts standard size punches and is compatible with automatic tool changers. Further, this invention provides an indexing means to provide proper orientation of shaped punches to ensure proper orientation of the shaped punch with the mating die. Misalignment of the shaped punch and die can result in premature tooling wear and punch fracture.

### DESCRIPTION OF THE INVENTION

Although the punch holder can be designed to be compatible with any type of automatic tool changer the preferred embodiment as detailed in this description is compatible with a well known machine type manufactured by W. A. Whitney, Inc. of Rockford, Ill. (FIG. 1).

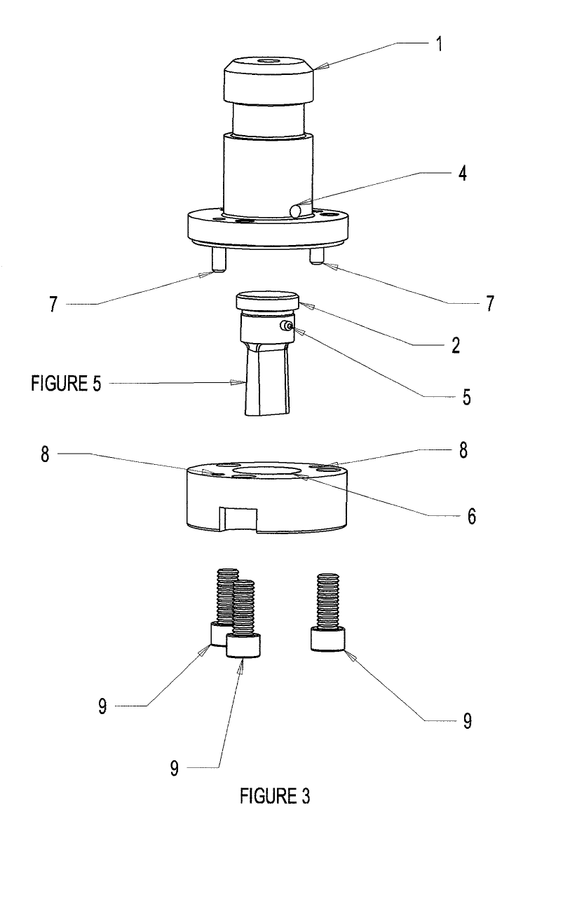

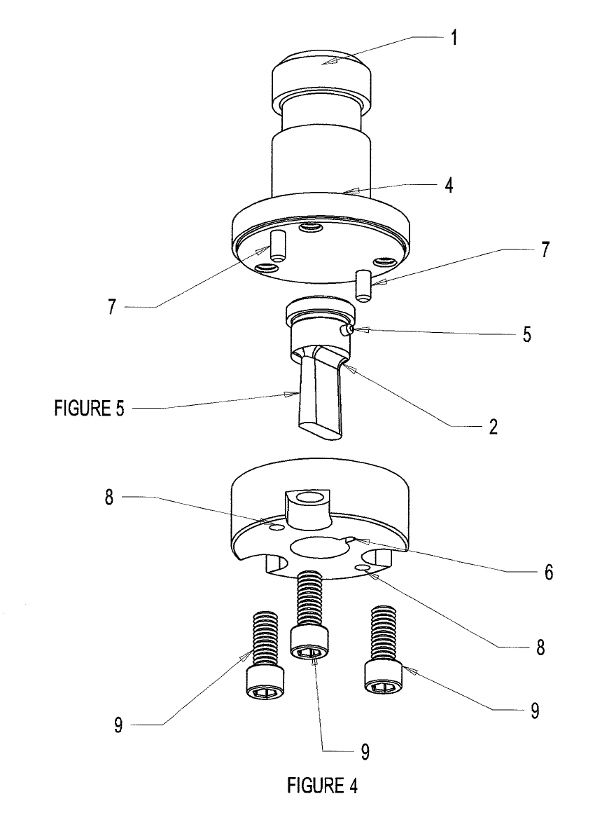

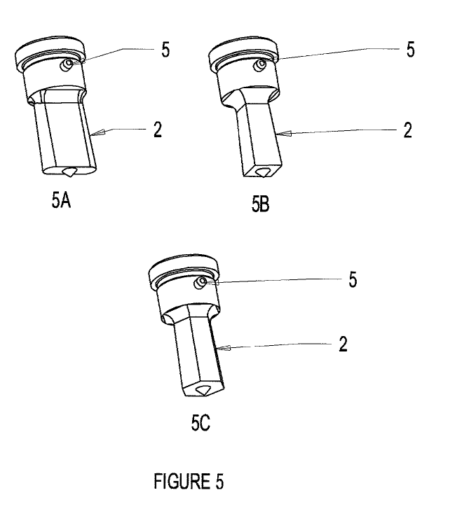

The punch holder (FIG. 3&4) consists of a punch holder body 1, a punch base 3, two assembly pins 4&5, two indexing pins 7, and a standard sized insert punch 2 (FIG. 5a, 5b, & 5c) which can be round or shaped.

The punch holder body is designed to fit an automatic tool changer (FIG. 2) and has an indexing pin 4 to define a unique position of the punch holder assembly in the tool changer and thereby a unique orientation in the automatic machine. The punch holder body 1 also has two assembly pins 7 in the holder face which in conjunction with the indexing pin 4 when assembled into the punch base 3 defines a unique assembly orientation of the base with the holder and the automatic tool changer.

The punch base 3 is designed to accept a standard insert punch 2 inserted through the bore of the base. The punch has an assembly pin 5 which in conjunction with the slot 6 in said punch base define a unique orientation between the punch and the punch base when assembled.

The insert punch 2 is a standard punch configuration with a hole in the shank to accept said indexing pin 5 which registers with said slot 6 in the punch base 3. When assembled in the punch base the indexing pin defines a unique orientation of the punch with the punch base. In conjunction with the orientation of the punch base and punch holder the punch orientation ensures precise alignment of the punch in the automatic tool changer wherein ensures precise alignment of the punch with the die during operation.

What is claimed is:

1. A punch holder which is compatible with automatic tool changers used in numerically controlled punch presses and accepts small size standard design punches. Said punch holder having an indexing slot to receive an indexing pin to orient shaped punches in the automatic tool changer to ensure proper alignment with the mating die. Wherein said punch holder allows use of inexpensive standard punches and reduces tooling costs. Said punch holder comprising:
a. A punch holder body with indexing pins and a shank which fits into the automatic tool changer.
b. A punch base with indexing holes to align with said punch holder body indexing pins and an alignment slot to index said insert punch.
c. An insert punch with an indexing pin, said indexing pin provides proper alignment of said punch with said punch base.
